(19) United States
(12) Patent Application Publication
(10) Pub. No.: US 2015/0277742 A1
(43) Pub. Date: Oct. 1, 2015

(54) WEARABLE ELECTRONIC DEVICE

(71) Applicant: CHENG UEI PRECISION INDUSTRY CO., LTD., New Taipei City (TW)

(72) Inventor: Chang Huat Lim, New Taipei City (TW)

(73) Assignee: CHENG UEI PRECISION INDUSTRY CO., LTD., New Taipei City (TW)

(21) Appl. No.: 14/231,867

(22) Filed: Apr. 1, 2014

(51) Int. Cl. G06F 3/0485; H04M 1/725; G06F 3/0488; G06F 3/0482; G06F 3/0484; G04G 21/08; G06F 3/041

(52) U.S. Cl. CPC G06F 3/04855; G04G 21/08; H04M 1/7253; G06F 3/041; G06F 3/0482; G06F 3/04842; G06F 3/0488

(57) ABSTRACT

A wearable electronic device includes an electronic assembly, and a rollable strap body connected with the electronic assembly. The electronic assembly includes a display screen, a touch sensing panel disposed on the display screen, and a processor disposed in the electronic assembly and electrically connected with the touch sensing panel. The display screen includes a display area for displaying a user interface. The touch sensing panel includes a one-dimensional horizontal instruction touch area for sensing horizontal moving signals, a one-dimensional longitudinal instruction touch area for sensing longitudinal moving signals, and a normally open instruction touch area for sensing clicking signals. The processor receives the horizontal moving signals, the longitudinal moving signals and the clicking signals for operating the user interface.

### BACKGROUND OF THE INVENTION

1. Field of the Invention

The present invention generally relates to a wearable electronic device, and more particularly to a wearable electronic device having a normally open instruction touch area in a display screen thereof.

2. The Related Art

Nowadays, intelligent terminals including smartphones, wearable electronic devices and others are developed towards high-speed, multifunctional and intelligent directions. The smartphones begin to combine with the wearable electronic devices, such as intelligent glasses, intelligent watches, intelligent wrist bands and so on, through highly flexible application programs for bringing conveniences to users' lives.

The smartphone can be connected with a network or the wearable electronic device through a wireless communication device to form a convenient intelligent internet.

Conventionally, the intelligent watch worn on the wrist of the user can be connected with the smartphone to further improve the life convenience. Specifically, a variety of functions of the smartphone, such as a time display function, a call function, a message function, a message reminder function, a physical fitness monitoring function, a photographing function, a music playing function and so on, can be acquired from the intelligent watch worn on the user's wrist.

However, perform two-dimensional operations on a smaller display screen of the intelligent watch in a long time, comparing with on the smartphone, eyesight burdens of the user are even more, and display information is apt to be covered when fingers of the user slide on the smaller display screen of the intelligent watch in the operating process. Moreover, the conventional intelligent watch uses a physical button as a switch, though a waterproof processing of the physical button is made, a waterproof extent of the switch is limited.

In order to overcome drawbacks of the wearable electronic device which is the intelligent watch described above, an operation method need be simplified to make the user operate the wearable electronic device by a one-dimensional intuition direction. Through reducing the operation dimension, it can decrease the burdens of the user's eyes when the user operates the wearable electronic device, and the display information is seldom to be covered. In addition, use a normally open instruction touch area in the display screen of the wearable electronic device as the switch for improving the waterproof extent of the switch.

### SUMMARY OF THE INVENTION

An object of the present invention is to provide a wearable electronic device. The wearable electronic device includes an electronic assembly, and a rollable strap body connected with the electronic assembly. The electronic assembly includes a display screen, a touch sensing panel disposed on the display screen, and a processor disposed in the electronic assembly and electrically connected with the touch sensing panel. The display screen includes a display area for displaying a user interface. The touch sensing panel includes a one-dimensional horizontal instruction touch area disposed in a top end or a bottom end of the display area for sensing horizontal moving signals, a one-dimensional longitudinal instruction touch area disposed in a left side or a right side of the display area for sensing longitudinal moving signals, and an normally open instruction touch area disposed in an edge of the display area for sensing clicking signals. The processor receives the horizontal moving signals, the longitudinal moving signals and the clicking signals for operating the user interface.

As described above, perform the one-dimensional operations on the smaller display screen of wearable electronic device by the touch sensing panel and the user interface of the wearable electronic device, the eyesight and mental burdens are decreased to be able to provide the more relax and intuitive operation way in the smaller display area for a user, and display information is seldom to be covered when fingers of the user slide on the smaller display screen of the wearable electronic device in the operating process. Furthermore, the wearable electronic device uses the normally open instruction touch area disposed in the display area as a switch, and comparing the normally open instruction touch area with a physical button, the normally open instruction touch area has a higher waterproof coefficient and a waterproof extent of the switch is without limitation.

### BRIEF DESCRIPTION OF THE DRAWINGS

The present invention will be apparent to those skilled in the art by reading the following description, with reference to the attached drawings, in which:

FIG. 1 is a front view of a wearable electronic device according to an embodiment of the present invention;

FIG. 2 is a schematic diagram of a menu item user interface displayed by a display area of the wearable electronic device of FIG. 1;

FIG. 3 is a schematic diagram of the wearable electronic device of FIG. 1, wherein the wearable electronic device is worn to a left hand of a user and is touched by a forefinger of a right hand of the user;

FIG. 4 is a schematic diagram of a selector user interface displayed by the display area of the wearable electronic device of FIG. 1;

FIG. 5 is a schematic diagram of a reader user interface displayed by the display area of the wearable electronic device of FIG. 1; and

FIG. 6 is a schematic diagram of an icon selecting user interface displayed by the display area of the wearable electronic device of FIG. 1.

### DETAILED DESCRIPTION OF THE EMBODIMENT

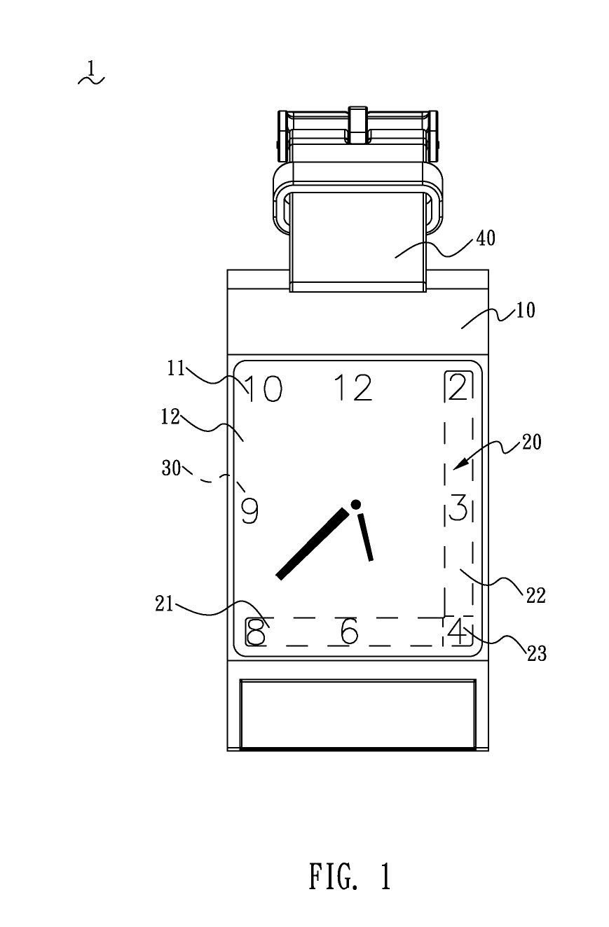

Referring to FIG. 1, a wearable electronic device 1 in accordance with an embodiment of the present invention is shown. The wearable electronic device 1 includes an electronic assembly 10 and a rollable strap body 40. The electronic assembly 10 includes a display screen 11, a touch sensing panel 20 and a processor 30. The rollable strap body 40 is connected with the electronic assembly 10 to make the wearable electronic device 1 capable of being worn on a wrist of a human body of a user. In this embodiment, the wearable electronic device 1 is an intelligent watch.

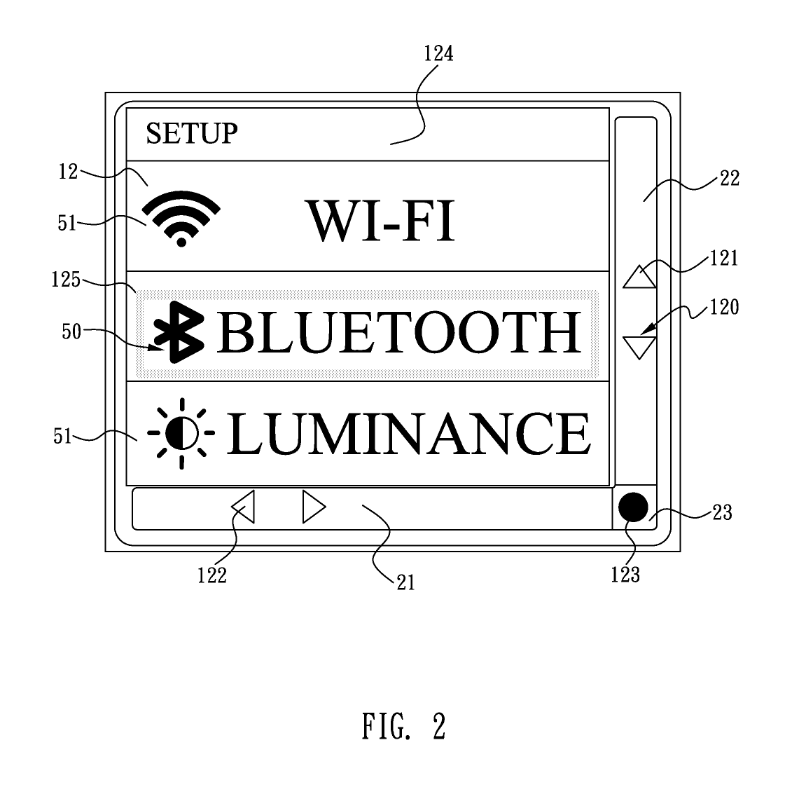

Referring to FIG. 1 and FIG. 2, the touch sensing panel 20 is disposed to a surface of the display screen 11 of the electronic assembly 10. The processor 30 is disposed in the electronic assembly 10 and is electrically connected with the touch sensing panel 20. The electronic assembly 10 further includes an electronic module (not shown) chosen from a combination of a WI-FI information element, a bluetooth function element, a microphone, a loudspeaker, a camera, an acceleration sensor and a gyroscope, a combination of the WI-FI information element, the bluetooth function element, the microphone, the loudspeaker, the camera, the acceleration sensor and a photoplethysmogram (PPG) measurement apparatus, or other combinations. The processor 30 receives signals of the electronic module described above for calculating multimedia information provided for the users to be received.

Referring to FIG. 1 and FIG. 2, the display screen 11 includes a display area 12 for displaying a user interface 120. The touch sensing panel 20 is a transparent panel.

Referring to FIG. 1 and FIG. 2, the touch sensing panel 20 includes a one-dimensional horizontal instruction touch area 21, a one-dimensional longitudinal instruction touch area 22 and a normally open instruction touch area 23. The horizontal instruction touch area 21 is disposed in a top end or a bottom end of the display area 12 for sensing horizontal moving signals. The longitudinal instruction touch area 22 is disposed in a left side or a right side of the display area 12 for sensing longitudinal moving signals. The normally open instruction touch area 23 is disposed in an edge of the display area 12 for sensing clicking signals. The processor 30 receives the horizontal moving signals, the longitudinal moving signals and the clicking signals for operating the user interface 120 to perform one-dimensional operations on the display screen 11 which is smaller.

Referring to FIG. 1, in this embodiment, the horizontal instruction touch area 21 is disposed in the bottom end of the display area 12. The longitudinal instruction touch area 22 is disposed in the right side of the display area 12. The normally open instruction touch area 23 is disposed at a lower right corner of the display area 12. The longitudinal instruction touch area 22 and the horizontal instruction touch area 21 of the touch sensing panel 20 are provided for the users to perform the one-dimensional operations on the smaller display screen 11 of the wearable electronic device 1. Such as identifying directions, distances and so on. The normally open instruction touch area 23 is provided for the users to perform zero-dimensional operations, such as identifying a clicking instruction, a double clicking instruction, a long press instruction and so on.

Referring to FIG. 1, a technical means of the touch sensing panel 20 is chosen as an acoustic wave type, a resistance type, a capacitor type, an electromagnetic type, an optical profile type and so on. The technical means is not limited to a specific type and is able to refer to a variety of sensing technologies in general.

Referring to FIG. 2, the display area 12 displays the user interface 120. The user interface 120 includes at least one longitudinal rolling prompt pattern 121, at least one horizontal rolling prompt pattern 122 or at least one clicking prompt pattern 123. The longitudinal rolling prompt pattern 121 and the longitudinal instruction touch area 22 are overlapped. The horizontal rolling prompt pattern 122 and the horizontal instruction touch area 21 are overlapped. The clicking prompt pattern 123 and the normally open instruction touch area 23 are overlapped. In this embodiment, the user interface 120 displays a longitudinal rolling prompt pattern 121, a horizontal rolling prompt pattern 122 and a clicking prompt pattern 123. The longitudinal rolling prompt pattern 121 and the longitudinal instruction touch area 22 are overlapped. The horizontal rolling prompt pattern 122 and the horizontal instruction touch area 21 are overlapped. The clicking prompt pattern 123 and the normally open instruction touch area 23 are overlapped.

Referring to FIG. 1 and FIG. 2, the processor 30 identifies a leftward instruction, a rightward instruction, an upward instruction, a downward instruction, a clicking instruction, a double clicking instruction and a switch instruction through receiving signals of the longitudinal instruction touch area 22, the horizontal instruction touch area 21 and the normally open instruction touch area 23 for controlling an item menu user interface 124.

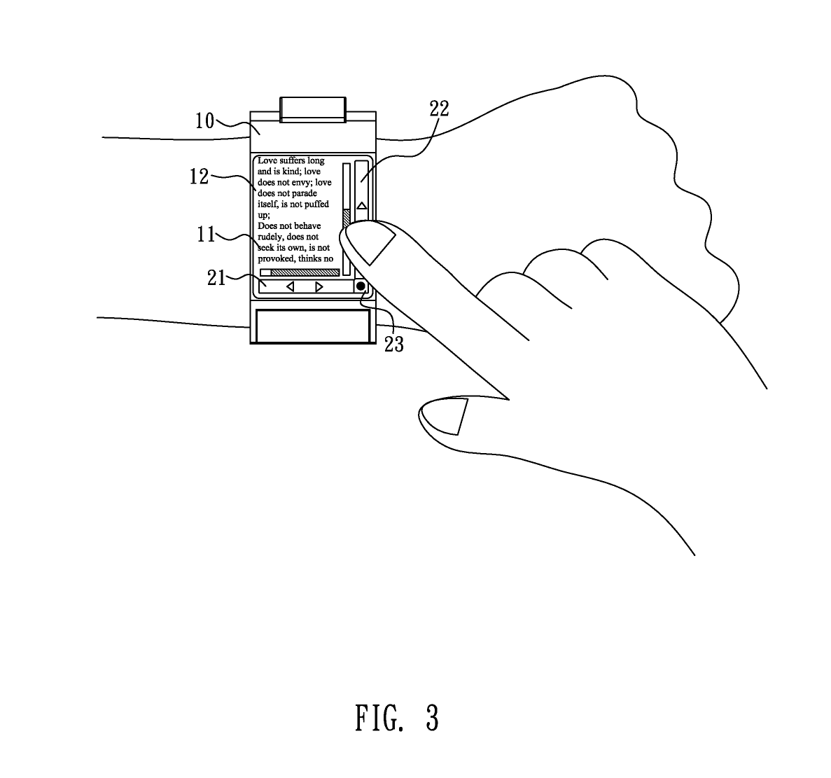

Referring to FIG. 1, FIG. 2 and FIG. 3, specifically, in view of the user interface 120, when the user touches the longitudinal instruction touch area 22 and makes the longitudinal instruction touch area 22 slide upward and downward, the processor 30 receives the upward and downward instructions of the longitudinal instruction touch area 22 and is able to interpret a longitudinal distance; when the user touches the horizontal instruction touch area 21 to slide leftward and rightward, the processor 30 receives the leftward and rightward instructions of the horizontal instruction touch area 21 and is able to interpret a horizontal distance. When the processor 30 receives a signal of the normally open instruction touch area 23 being clicked, the processor 30 performs a selection instruction on the user interface 120. When the processor 30 receives a signal of the normally open instruction touch area 23 being double clicked within a limited timespan, the processor 30 performs an instruction of going back to a previous level of the user interface 120. When the processor 30 receives a signal of the normally open instruction touch area 23 being kept being touched to a preset time, the processor 30 performs a switch instruction.

Furthermore, the normally open instruction touch area 23 chooses a normally open touching sensor to do a motion sensing, namely, the normally open touching sensor is capable of sensing and transmitting signals under a condition of power energies being provided for the wearable electronic device 1 to make the normally open instruction touch area 23 act as a switch of the wearable electronic device 1.

Referring to FIG. 1, FIG. 2 and FIG. 3, according to the embodiment of the present invention, the wearable electronic device 1 is worn on the wrist of a left hand of the user, and is touched by a forefinger of a right hand of the user. It can be obviously seen that a moving area of the forefinger is located at the edge of the display area 12, so the user can clearly see and operate the user interface 120. Sight line will not be obstructed by the right hand, and it can operate the user interface 120 more intuitively through the one-dimensional operation way. Comparing with the two-dimensional operation way of the intelligent watch in prior art, an operation method of the touch sensing panel 20 makes eyeballs of the user needn't track the two-dimensional coordinates of the display screen 11, so eyesight and mental burdens are decreased to be able to provide the more relax and intuitive operation way in the smaller display area 12 for the user so as to appropriate for being used in the operation of the user interface 120 on the smaller display screen 11. Display information is seldom to be covered when fingers of the user slide on the smaller display screen 11 of the wearable electronic device 1 in the operating process.

Referring to FIG. 1 and FIG. 2, the wearable electronic device 1 in accordance with the present invention can simplify a control way of the user operation interface through the touch sensing panel 20. A specific operation way is shown as an item menu user interface 124. When the display area 12 displays a selecting menu 50 having multiple data items 51 and has a selecting bar 125, the selecting bar 125 selects the data item 51 below after the longitudinal instruction touch area 22 is slid upward for a distance by the user, and the selecting bar 125 selects the data item 51 above after the longitudinal instruction touch area 22 is slid downward for a distance by the user.

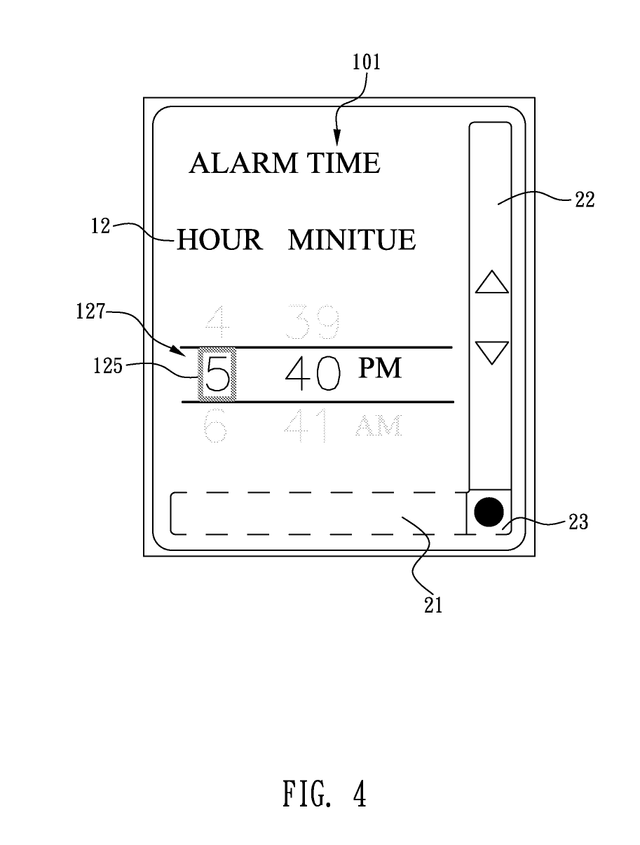

Referring to FIG. 4, a selector user interface 101 is shown. When the display area 12 displays at least one selector 127 of figures, letters or words, and appears the selecting bar 125, the selector 127 moves the next sequential figures, letters or words to the selecting bar 125 after the longitudinal instruction touch area 22 is slid upward for a distance by the user, and the selector 127 rolls the previous sequential figures, letters or words to the selecting bar 125 after the longitudinal instruction touch area 22 is slid downward for a distance by the user.

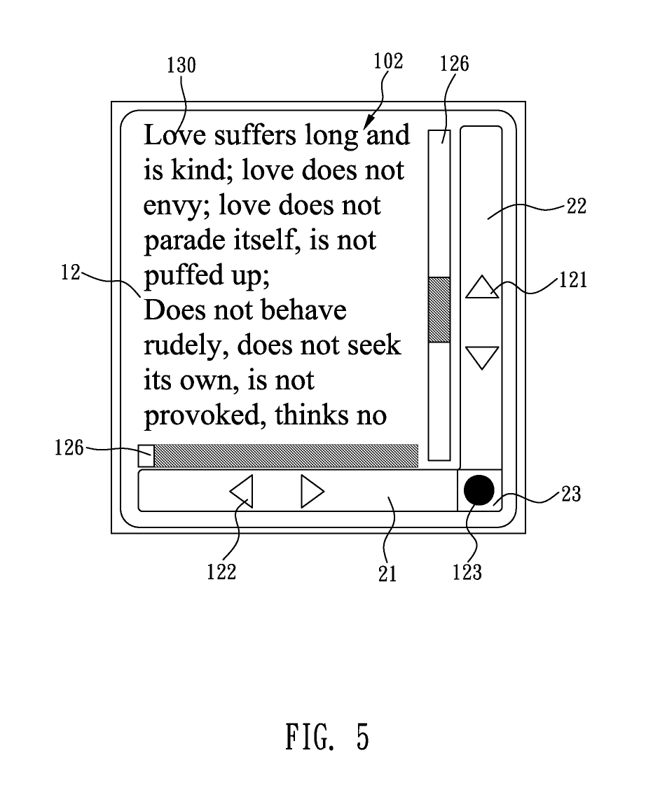

Referring to FIG. 5, a reader user interface 102 is shown. When the display area 12 displays a page 130 of patternings or words, and the display area 12 displays a scroll 126 in the left side or the right side thereof, content of the page 130 is moved upward and the scroll 126 is moved downward after the longitudinal instruction touch area 22 is slid upward for a distance by the user, and the content of the page 130 is moved upward and the scroll 126 is moved upward after the longitudinal instruction touch area 22 is slid downward for a distance by the user. When the display area 12 displays the scroll 126 in the top end or the bottom end thereof, the content of the page 130 moves leftward and the scroll 126 moves rightward after user slides leftward the horizontal instruction touch area 21 for a distance, and the content of the page 130 moves rightward and the scroll 126 moves leftward after the user slides rightward the horizontal instruction touch area 21 for a distance.

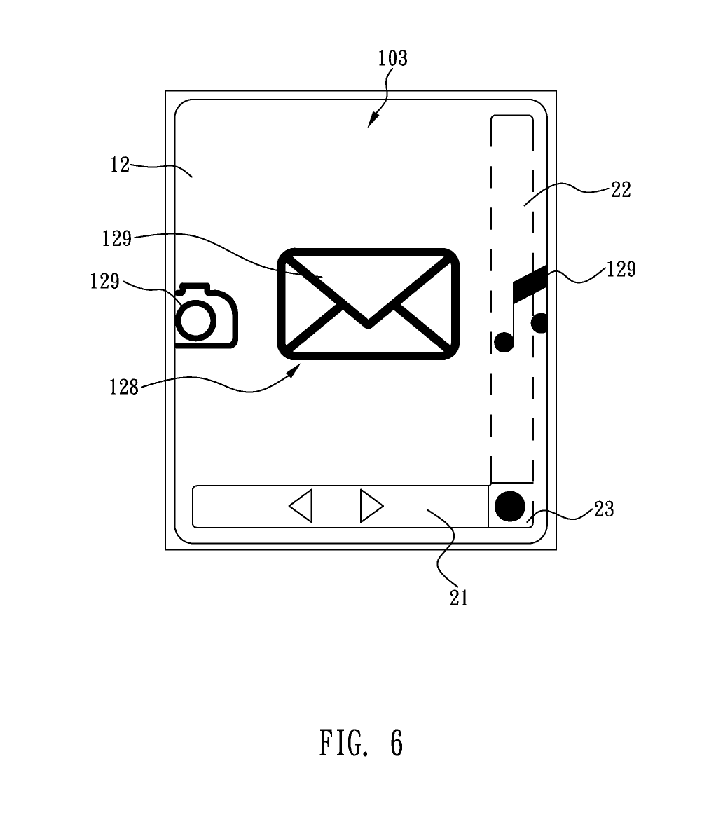

Referring to FIG. 6, an icon selecting user interface 103 is shown. When the display area 12 displays a logo menu 128, another logo 129 arranged at a right side of a logo 129 located at a center of the display screen 11 is moved to a middle of the display screen 11 after the horizontal instruction touch area 21 is slid leftward for a distance, and another logo 129 arranged at a left side of the logo 129 located at the center of the display screen 11 is moved to the middle of the display screen 11 after the horizontal instruction touch area 21 is slid rightward for a distance.

As described above, perform the one-dimensional operations on the smaller display screen 11 of wearable electronic device 1 by the touch sensing panel 20 and the user interface 120 of the wearable electronic device 1, the eyesight and mental burdens are decreased to be able to provide the more relax and intuitive operation way in the smaller display area 12 for the user, and the display information is seldom to be covered when the fingers of the user slide on the smaller display screen 11 of the wearable electronic device 1 in the operating process. Furthermore, the wearable electronic device 1 uses the normally open instruction touch area 23 disposed in the display area 12 as the switch, and comparing the normally open instruction touch area 23 with a physical button, the normally open instruction touch area 23 has a higher waterproof coefficient and a waterproof extent of the switch is without limitation.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A wearable electronic device, comprising:
an electronic assembly including a display screen, a touch sensing panel disposed on the display screen, and a processor disposed in the electronic assembly and electrically connected with the touch sensing panel, the display screen including a display area for displaying a user interface, the touch sensing panel including a one-dimensional horizontal instruction touch area disposed in a top end or a bottom end of the display area for sensing horizontal moving signals, a one-dimensional longitudinal instruction touch area disposed in a left side or a right side of the display area for sensing longitudinal moving signals, and a normally open instruction touch area disposed in an edge of the display area for sensing clicking signals, the processor receiving the horizontal moving signals, the longitudinal moving signals and the clicking signals for operating the user interface; and
a rollable strap body connected with the electronic assembly.

2. The wearable electronic device as claimed in claim 1, wherein the horizontal instruction touch area is disposed in the bottom end of the display area, the longitudinal instruction touch area is disposed in the right side of the display area, and the normally open instruction touch area is disposed at a lower right corner of the display area.

3. The wearable electronic device as claimed in claim 1, wherein the normally open touching sensor is capable of sensing and transmitting signals under a condition of power energies being provided for the wearable electronic device.

4. The wearable electronic device as claimed in claim 1, wherein the user interface includes at least one longitudinal rolling prompt pattern, at least one horizontal rolling prompt pattern or at least one clicking prompt pattern, the longitudinal rolling prompt pattern and the longitudinal instruction touch area are overlapped, the horizontal rolling prompt pattern and the horizontal instruction touch area are overlapped, the clicking prompt pattern and the normally open instruction touch area are overlapped.

5. The wearable electronic device as claimed in claim 4, wherein the user interface includes a longitudinal rolling prompt pattern, a horizontal rolling prompt pattern and a clicking prompt pattern, the longitudinal rolling prompt pattern and the longitudinal instruction touch area are overlapped, the horizontal rolling prompt pattern and the horizontal instruction touch area are overlapped, the clicking prompt pattern and the normally open instruction touch area are overlapped.

6. The wearable electronic device as claimed in claim 1, wherein when the display area displays a selecting menu having multiple data items and has a selecting bar, the selecting bar selects the data item below after the longitudinal instruction touch area is slid upward for a distance, and the selecting bar selects the data item above after the longitudinal instruction touch area is slid downward for a distance.

7. The wearable electronic device as claimed in claim 1, wherein when the display area displays at least one selector of figures, letters or words and appears a selecting bar, the selector moves the next sequential figures, letters or words to the selecting bar after the longitudinal instruction touch area is slid upward for a distance, and the selector rolls the previous sequential figures, letters or words to the selecting bar after the longitudinal instruction touch area is slid downward for a distance.

8. The wearable electronic device as claimed in claim 1, wherein when the display area displays a page of patternings or words, and the display area displays a scroll in the left side or the right side thereof, content of the page is moved upward and the scroll is moved downward after the longitudinal instruction touch area is slid upward for a distance, and the content of the page is moved upward and the scroll is moved upward after the longitudinal instruction touch area is slid downward for a distance.

9. The wearable electronic device as claimed in claim 1, wherein when the display area displays a page of patternings or words, and the display area displays a scroll in the top end or the bottom end thereof, content of the page moves leftward and the scroll moves rightward after the horizontal instruction touch area is slid leftward for a distance, and the content of the page moves rightward and the scroll moves leftward after the horizontal instruction touch area is slid rightward for a distance.

10. The wearable electronic device as claimed in claim 1, wherein when the display area displays a logo menu, another logo arranged at a right side of a logo located at a center of the display screen is moved to a middle of the display screen after the horizontal instruction touch area is slid leftward for a distance, and another logo arranged at a left side of the logo located at the center of the display screen is moved to the middle of the display screen after the horizontal instruction touch area is slid rightward for a distance.

11. The wearable electronic device as claimed in claim 1, wherein when the processor receives a signal of the normally open instruction touch area being clicked, the processor performs a selection instruction on the user interface, when the processor receives a signal of the normally open instruction touch area being double clicked within a limited timespan, the processor performs an instruction of going back to a previous level of the user interface, when the processor receives a signal of the normally open instruction touch area being kept being touched to a preset time, the processor performs a switch instruction.
